(19) United States
(12) Patent Application Publication
(10) Pub. No.: US 2014/0143018 A1
(43) Pub. Date: May 22, 2014

(54) Predictive Modeling from Customer Interaction Analysis

(71) Applicant: Verint Americas Inc., Melville, NY (US)

(72) Inventors: James G. Nies, Carmel, IN (US); Joseph Watson, Alpharetta, GA (US); Oren Stern, Alpharetta, GA (US); Martin McCreesh, Dunleer (IE)

(73) Assignee: VERINT AMERICAS INC., Melville, NY (US)

(21) Appl. No.: 14/083,772

(22) Filed: Nov. 19, 2013

Related U.S. Application Data
(60) Provisional application No. 61/729,073, filed on Nov. 21, 2012.
(60) Provisional application No. 61/729,074, filed on Nov. 21, 2012.

(51) Int. Cl. G06Q 30/00; G06Q 30/02

(52) U.S. Cl. CPC G06Q 30/016; G06Q 30/0201
USPC 705/7.32; 705/7.29

(57) ABSTRACT

Systems and methods of predictive modeling of customer interaction content data include the collection of customer interaction content data. The collected customer interaction content data is analyzed to create structured data. At least one predictive analysis algorithm is applied to the restored data. At least one prediction of an outcome is produced based upon the application of the predictive analysis algorithm. At least one automated response is generated to the at least one prediction.

### CROSS-REFERENCE TO RELATED APPLICATION

The present application claims priority of U.S. Provisional Patent Application Nos. 61/729,073 and 61/729,074, both of which were filed on Nov. 21, 2012, the contents of which are hereby incorporated herein by reference in their entireties.

### BACKGROUND

The present disclosure is related to the field of predictive modeling. More specifically, the present disclosure is related to analysis of customer interactions to predict likely outcomes.

Recent developments in the archival and quantification of interactions have led to increased efforts in the analysis of these sources of information. One aspect of analysis is predictive modeling, wherein based upon previous interactions or databases of historical events or outcomes, assumptions are made regarding future outcomes of a specific interaction.

Examples of current systems involve a single monitoring channel, exemplarily survey data or voice data. These systems provide analysis of individual interactions and trends based upon results within that monitoring channel. These systems may be applied in consumer or service settings for example to customer behavior, exemplarily through cross-sale offers made by online retailers.

However, such predictions based upon on individual channel of information may provide an incomplete picture of the real events, and likewise result in inaccurate, or at the very least, unpredictive results or conclusions.

### BRIEF DISCLOSURE

An embodiment of a method of predictive modeling of customer interaction content data includes the collection of customer interaction content data. The collected customer interaction content data is analyzed to create structured interaction content data. At least one predictive analysis algorithm is applied to the structured data. At least one prediction of an outcome based upon the application of the at least one predictive analysis algorithm to the structured data is produced. At least one automated response to the at least one prediction is generated.

In an alternative exemplary embodiment of a method of predictive modeling of customer interaction data, customer interaction content data is collected. The collected customer interaction content data is analyzed to create structured interaction content data. At least one predicted analysis algorithm is derived from the structured interaction content data. The at least one predictive analysis algorithm is applied to a real-time stream of customer interaction content data acquired from an interaction between a customer and a customer service agent. At least one intra-interaction analysis is presented at a workstation for the customer service agent.

An exemplary embodiment of a system for predictive modeling of customer interaction data includes a computer readable medium upon which customer interaction content data is stored. The customer interaction content data includes interaction recordings, transactional data, desktop analytics, and customer feedback surveys. A processor is communicatively connected to the computer readable medium upon which the customer interaction content data is stored. The processor analyzes the customer interaction content data to create structured data. The processor applies at least one predictive analysis algorithm to the structured data to result in at least one customer prediction, at least one employee prediction, and at least one business prediction. The processor creates at least one customer response from the customer prediction, at least one employee response form the employee prediction, and at least one business response from the business prediction. A first workstation that includes a graphical display is operated by the processor to automatedly present the customer response. A second workstation that includes a graphical display is communicatively connected to the processor and configured to present the employee response and business response.

### BRIEF DESCRIPTION OF THE DRAWINGS

FIG. 1 is a flowchart that depicts an exemplary embodiment of a method of predictive modeling from customer interaction content.

FIG. 2 is a system diagram of an exemplary embodiment of a system for predictive modeling.

FIG. 3 is a flowchart that depicts an exemplary embodiment of a method of predictive modeling of real-time customer interaction content.

### DETAILED DISCLOSURE

In the field of customer interaction analysis, any channels of unstructured data can be monitored. These channels of unstructured data can be include voice, screen, or video recordings, received customer transactional information, desktop use information and/or customer surveys. As disclosed herein, the output from one or more of these channels can be normalized such as with pattern analysis to create structured data from these free form sources. Predictive analytics can be applied to the normalized customer service interaction information across a wide range of inputs and from multiple customer service interactions to identify insight or trends that are not apparent from analysis of a single channel of information or across a single interaction. The analysis can be presented to a user such as an employee or customer service agent in an actionable context rather than simply providing the analysis at the channel or interaction level.

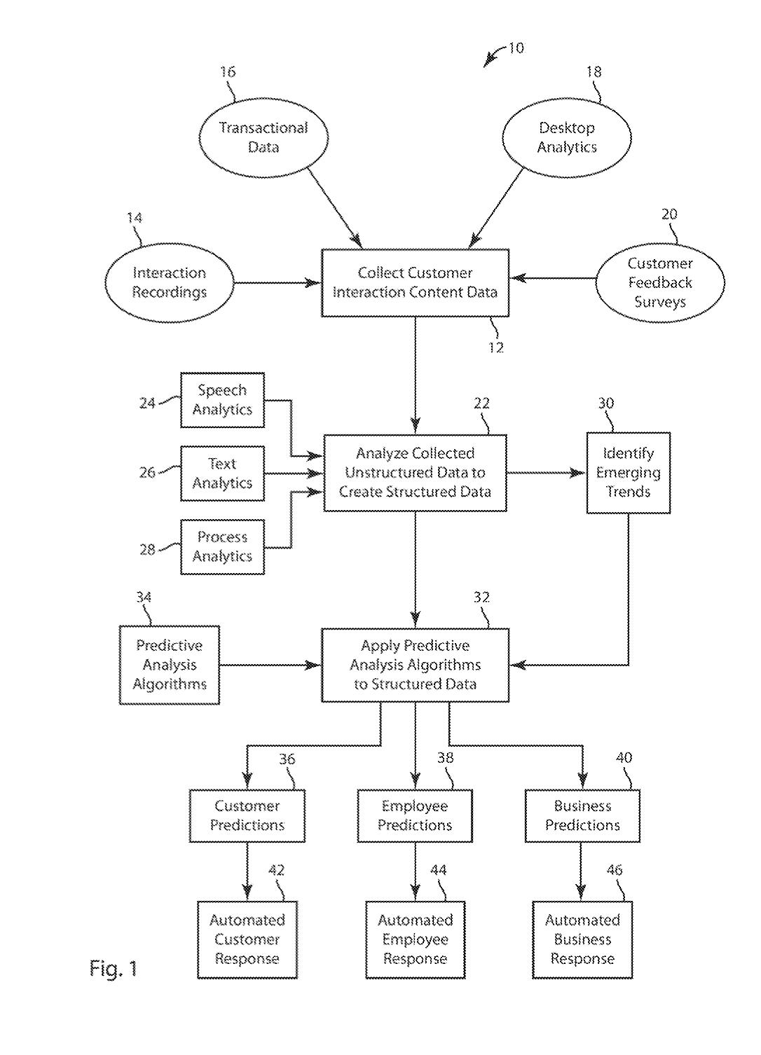

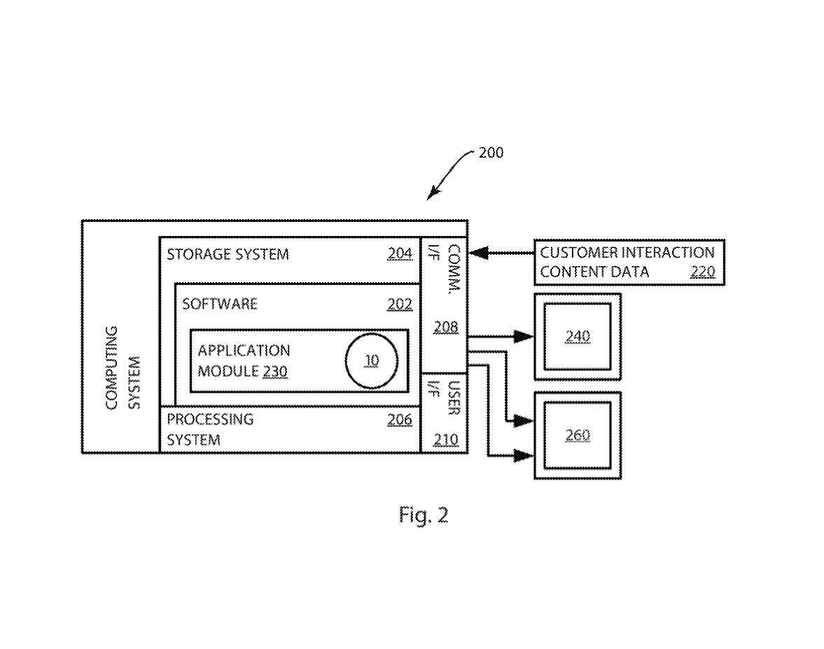

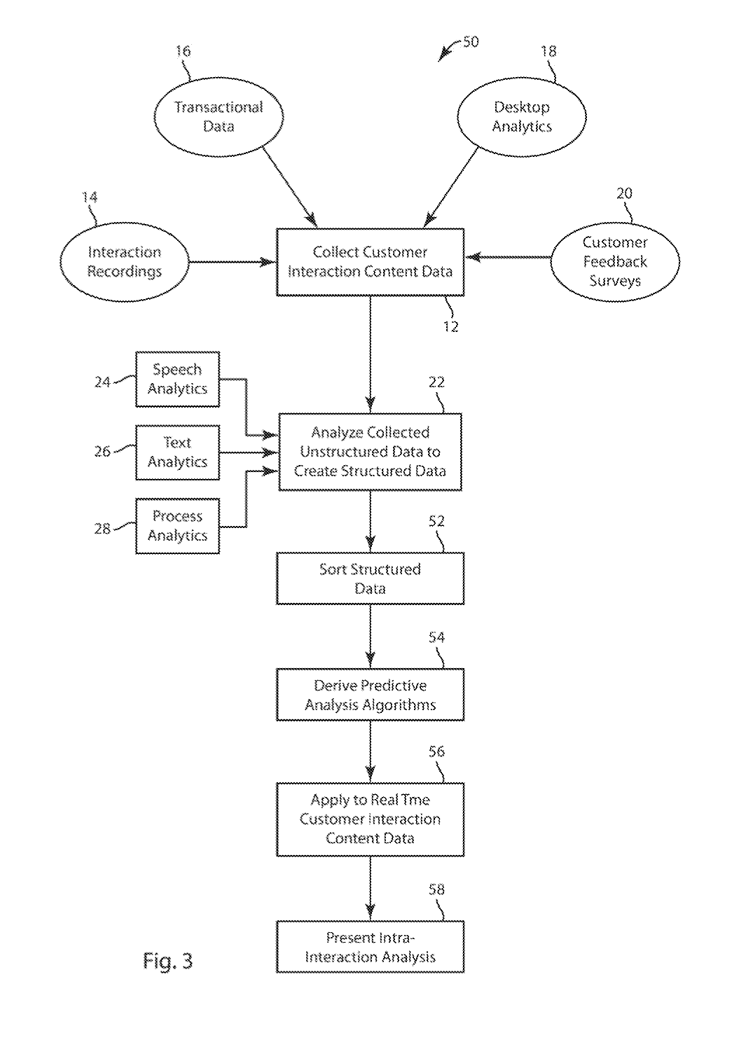

FIGS. 1 and 3 are flow charts that depict exemplary embodiments of methods of predictive modeling from analysis of customer interaction content. FIG. 2 is a system diagram of an exemplary embodiment of a system 200 for predictive modeling in the manner as described herein with respect to the embodiments of the method disclosed with respect to FIGS. 1 and 3. The system 200 is generally a computing system that includes a processing, system 206, storage system 204, software 202, communication interface 208, and a user interface 210. The processing system 206 loads and executes software 202 from the storage system 204, including a software module 230. When executed by the computing system 200, software module 230 directs the processing system 206 to operate as described herein, in further detail in accordance with the methods 10 and 50 depicted in FIGS. 1 and 3.

Although the computing system 200 as depicted in FIG. 2 includes one software module in the present example, it should be understood that one or more modules could provide the same operation. Similarly, while the description as provided herein refers to a computing system 200 and a processing system 206, it is to be recognized that implementations of such systems can be performed using one or more processors, which may be communicatively connected and such implementations are considered to be within the scope of the description.

The processing system 206 can include a microprocessor and other circuitry that retrieves and executes software 200 from storage system 204. Processing system 206 can be implemented within a single processing device, but can also be distributed across multiple processing devices or sub-systems that cooperate in executing program instructions. Examples of processing system 206 include general purpose central processing units, application specific processors, and logical devices, as well as any other type of processing device, combinations of processing devices, or variations thereof.

The storage system 240 can include any storage media readable by a processing system 206, and capable of storing software 202. The storage system 204 can include volatile and non-volatile, removable and non-removable media implemented in any method of technology for storage of information, such as computer readable instructions, data structures, program modules, or other data. Storage system 204 can be implemented as a single storage device but may also be implemented across multiple storages devices or sub-systems. Storage system 204 can further include additional elements, such as a controller, capable of communicating with the processing system 206.

Examples of storage media include random access memory read-only memory, magnetic discs, optical discs, flash memory discs, virtual and non-virtual memory, magnetic sets, magnetic tape, magnetic disc storage or other magnetic storage device, or any other medium which can be used to store the desired information and that may be accessed by an instruction execution system, as well as any combination or variation thereof or any other type of storage media. In some implementations, the storage media can be a non-transitory storage media.

User interface 210 can include a mouse, a keyboard, a voice input device, a touch input device for receiving a gesture from a user, motion input device for detecting non-touch gesture and other motions by a user, and other comparable input devices and associated processing elements capable of receiving user input from a user. Output devices such as a video display or a graphical display and display an interface further associated with embodiments of the system and method as disclosed herein. Speakers, printers, haptic devices, and other types of output devices may also be included in the user interface 210.

As described in further detail herein, the computing system 200 receives customer interaction on content data 220. In exemplary embodiments, the customer interaction content data 220 may include any of a variety of customer interactions and resulting data files including, but not limited to audio recordings of customer service interactions, interactive voice recorder (IVR) responses, web chat transcripts, e-mail, text or other SMS messages, social media, website interaction, and web or mobile survey responses. In one exemplary embodiment, the customer interaction content data 220 includes audio data of a customer service interaction exemplary between a customer service agent and a customer that was previously recorded and stored or is streamed in real-time. In embodiments, the processor 206 may operate to transform or partially transform the received customer interaction content data 220 into a text form for further processing through rules and analytics which may be stored as part of the application module 230 as described in further detail herein. In still further exemplary embodiments, the customer interaction content data 220 may further include desktop or workspace analytics regarding one or more customer service agents. The desktop or workspace analytics may include a time stamped log of functions, applications and inputs made to a customer service agent's workstation, while in further embodiments may include video data of the customer service agent at the agent's work station. In a still further embodiment, the customer interaction content data 220 further includes customer transactional data, exemplarily purchases, returns, or service history. Additionally, the customer interaction content data 220 can include customer survey result data. In embodiments, the customer interaction content data 220 may be related, grouped, or associated by a customer identification number or account number such that the customer interaction content data 220 can optionally be analyzed as disclosed herein on a customer by customer basis.

As will be described in further detail herein, the processing system 208 receives the customer interaction content data 220 and processes the received data, first with analytics techniques, exemplarily speech analytics, text analytics, and process analytics as described in further detail herein. The analytic techniques and algorithms may be a part of the application module 230, or may be stored at the storage system 204 and accessed by the processing system 206 and application module 230.

In embodiments, the processing system 206, by operation of the application module 230 further applies predictive analysis algorithms, similarly stored as a part of the application module 230 or separately at the storage system 204 to the processed customer interaction content data to result in predictions and/or guidance as disclosed in greater detail herein. While in embodiments, the predictions and/or guidance may be presented at the user interface 210, the exemplary embodiment depicted in FIG. 2, the system 200 further comprises at least one agent workstation 240 which includes a graphical display and automated customer responses 250 are provided from the processing system 206 to the agent workstation 240 via the communication interface 208. Similarly, the system 200 further comprises at least one management workstation 260 which includes a graphical display and automated employee responses 270 and automated business responses 280 are provided from the processing system 206 to the management workstation 260 via the communication interface 208.

FIG. 1 is a flow chart that depicts an embodiment of a method 10 for predictive modeling by analysis of customer interaction content data. It will be understood that systems that implement an embodiment such as that depicted in FIG. 1 may be implemented through the use of one or more computers that execute computer readable code and may form a computer network with multiple computers and/or computer readable media operating to perform various data storage, data processing, serving, or user workstation capabilities exemplarily as described above with respect to FIG. 2 to carry out the processes as disclosed herein.

In FIG. 1 at 12, customer interaction content data is collected. The collected customer interaction content data can be any of a variety of data including interaction recordings 14, transactional data 16, desktop analytics 18, or customer feedback surveys 20. As will be described in further detail herein, in embodiments, the data from each of these sources of customer interaction content data may be associated to a customer identification or account number, such that cross-channel analysis of all customer interactions with a particular customer may be analyzed as a group to provide greater context to any piece of customer interaction content data.

As a merely exemplary embodiment, an example of a customer service operation or call center will be used to provide non-limiting examples in context within this disclosure. A person of ordinary skill in the art will recognize that the systems and methods as disclosed herein can be used in other contexts or applications while still remaining within the scope of the present disclosure.

Returning to the method 10 of FIG. 1, non-limiting examples of the interaction recordings 14 can include voice, screen, and/or video recordings of the customer service agent, or the agent's workstation during a customer service interaction, exemplarily a customer service call for technical support for a new product, to process a product return, purchase a new product or service, upgrade, downgrade, or cancel current services. The interaction recordings may be audio data or may be textual transcripts of a telephonic interaction or a text-based interaction such as web-chat. In still further embodiments, the interaction recordings 14 can further include discrete events or unidirectional interactions from the customer, such as, but not limited to, social medial or website posts or interactions and emails.

Transactional data 16 can exemplarily be the status of a customer or a case including an outcome, if any, customer service agent notes, or other information about the customer collected by the customer service agent and entered into the computer system. In exemplary embodiments, the transactional data 16 may be customer purchase, return, or warranty claim history, which may be collected by another system or application and associated to the customer's identification or account number.

Desktop analytics 18 may exemplarily include notation or identification of specific applications or application modules used during the customer interaction or transaction, particular events that occur on the desktop during the customer interaction, or tasks performed by the customer service agent during the customer interaction by using the workstation including an order in which tasks or events occur. In an exemplary embodiment, the desktop analytics 18 may be a time stamped log of actions and processes taken at the customer service agent's workstation. In an embodiment, this time stamped log may be correlated to or associated with one or more interaction recordings 14 of the customer service interaction which the agent was processing at the workstation.

Customer feedback survey 20 may similarly be associated to a customer identification or account number and may be any of a variety of available customer feedback survey formats and lengths. In non-limiting embodiments., the customer feedback surveys may be interactive voice recording (IVR) surveys, e-mail, website enabled, or short message service (SMS) based customer feedback surveys. The customer feedback surveys at 20 may include quantitative or numerical answers (e.g. “rate customer service on a scale of 1-5”), while in other embodiments, the customer feedback survey responses may be free form speech or text responses.

At 22, the collected unstructured data is analyzed in order to create structured data which may be of a normalized format to facilitate cross channel analysis. The analysis at 22 can include the application of techniques and/or algorithms such as speech analytics 24, text analytics 26, and/or process analytics 28. Non-limiting examples of speech analytics 24 can include analysis of voice recordings made during the customer service interaction or analysis of audio responses received from automated customer feedback surveys. Non-limiting examples of text analytics 26 can include contextual analysis of the received transactional information, text analytics of verbatim text responses to customer feedback surveys, such as email surveys, or text analytics of customer interaction transcripts. Process analytics 28 may include a process analysis of desktop events to recognize applications, processes, and orders of events that take place during the course of a customer service interaction.

In an exemplary embodiment, the analysis at 22 may further include the automated transcription of audio data into a textual format, and then the application of text analytics techniques 26. The speech analytics 24 and text analytics 26 may use contextual analysis to identify specific content spoken by either the customer or the agent and from this identified content identify themes, topics, or sentiment in the interaction. These identified themes, topics, or sentiments may be formed into the structured data for further analysis. In embodiments, the customer interaction content data may be grouped or associated by customer identification or account number and the structured data organized to exemplarily relate the themes, topics or sentiments of a customer service interaction to the desktop actions taken by the agent during the customer service interaction, a transaction, such as a purchase that resulted from the customer service, interaction, and a customer feedback survey response from the customer regarding the customer service interaction.

In some embodiments the structured data may be analyzed at 30 to identify emerging trends or issues in the collected customer interaction content data. Exemplarily, a product defect or technical concern may be identified early by noticing an increase in product warranty or technical support customer interactions regarding a particular product, or an increase in a particular topic (e.g. “home button”, “screen”, or “charger” for a cell phone product) in customer service interactions. When available, associate customer feedback surveys can further provide insight as to how such m emerging topic or trend may impact future consumer sentiments.

At 32, predictive analysis algorithms can be applied to the structured data produced at 22 in order to arrive at a variety of predictions or insights into the customer interactions or transactions. In order to apply predictive analysis algorithms at 32, the predictive analysis algorithms must be accessed at 34, which may be from a computer readable medium upon which the algorithms are stored as exemplarily described herein with respect to FIG. 2. A variety of analysis algorithms may be used in varying embodiments, including but not limited to: cluster analysis, linear regression, fuzzy logic, or advanced neural networks. However, these specific techniques are not intended to be limiting on the scope of predictive analysis algorithms that may be applied to the structured data in order to arrive at the produced insights or predictions.

While embodiments of predictive analysis algorithms are described in further detail herein, in some embodiments, the predicative analysis algorithm may reflect complex relationships between associated pieces of customer interaction content. Exemplarily, the predictive analysis algorithms may define relationships between the interaction communication between the agent and the customer and the desktop actions taken by the agent during a customer service interaction with the additional context of any associated results from any other forms of customer interaction recordings, transactional data and customer evaluation from customer feedback surveys. While in still further embodiments, the predictive analysis algorithm may define a normal or expected customer service interaction, agent desktop actions, and/or transactional data relative to various identified topics, themes, or sentiments. These definitions can be then used to identify interactions that are abnormal and suitable for further investigation or intervention. In a still further embodiment, those customer service interactions that have been deemed to be undesirable customer service interactions, exemplary through information provided by the transactional data or customer feedback surveys may be aggregated in order to identify the characteristics of an undesirable interaction. These characteristics can then be used in analysis of future customer service interactions, or as described in further detail herein to prompt appropriate responses.

The predictive analysis produced at 32 can come in a variety of forms such as customer predictions 35, employee predictions 38, or business predictions 40. Non-limiting examples of customer predictions may include a prediction of future behavior of individual customers, such as increasing spending, decreasing spending, or terminating contracts. Employee predictions 38 could include predicting future behavior of individual employees, such as termination of employment, performing at the top 20th percentile or performing at the bottom 20th percentile. Examples of business predictions 40 can include predicting a quality score on customer feedback survey responses received from customers after a customer service interaction based upon compliance with established process and/or service standards or the detection of outliers among individual employees or specific types of customer service interactions that suggest an increased risk or an emerging issue to the business.

Embodiments as disclosed herein of the method can predict or identify a variety of customer/business/employee events or issues and provide an appropriate automated response. An automated response may be generated in response to any customer predictions 34, employee predictions 38, or business predictions 40, resulting in an automated customer response 42, employee response 44, or business response 46. As described above exemplarily customer predictions or responses may be provided to a customer service agent while employee or business predictions or responses may be provided to management.

An automated response, which in an embodiment may be a report, is generated based upon the one or more predictions produced at 32. The automated responses or reports may include real-time activities during a current or future customer service interaction. Such real-time activities could include pop up notifications or reminders during a customer service interaction such as to offer the customer a promotion, up sell, or discount; provide the customer service agent with a script or script portion at a particular location or in response to an event in the customer interaction; or open a desktop application and auto populate the application with customer information. The automated response or report may alternatively a prompt to further review customer interactions to search out or identify a root cause of an identified emerging issue or source of an identified customer service issue. Still further embodiments may provide additional insight or analysis that can be used to create or enhance educational or coaching materials for customer service agents or other employees. Such education or coaching materials can provide specific examples or portions of specific customer service interactions from that individual or from other employees used as model customer interactions to illustrate employee coaching or training concepts.

In exemplary embodiments, an automated customer service response 42 may be a prompt or pop-up notification to a customer service agent to identify a cross sell or up sell opportunity to the customer service agent and provide the agent with guidance or information regarding this opportunity. Customers at a particularly high risk for turnover or churn can be identified, resulting in an automated response of a prompt to a customer service agent during a customer interaction to remind the customer service agent of customer retention promotions or other available perks or customer service follow ups that may be provided to retain such an identified customer.

In exemplary embodiments of business predictions 40 and associated automated responses 46, future sources of negative customer interactions may be identified as an emerging issue through open ended or trending customer service topics or issues. As a non-limiting example, early adopters of a new product may typically be more forgiving of new product defects or issues. Therefore, customer service interactions may identify an emerging problem, but customer satisfaction, such as reported by customer surveys, may remain high. However, as further sales are made to a larger customer base, including to customers who are less brand committed, these same issues may be a source of low customer satisfaction if the issue has not been resolved. Therefore, cross-channel predictive analysis may provide a business with further product information or advise the business how to direct product support efforts.

In exemplary embodiments of employee predications 38 and associated automated employee responses 44, analysis of particular customer service agent actions, mistakes, or habits may be used to predict or identify whether or not certain new employees will either struggle or excel in a current position or employment task. Interventions such as training, guidance, or coaching may be automatically scheduled for identified struggling employees before customer service, is impacted. In still further embodiments, analysis of employee actions may result in predications that an employee will quit and/or become to threat to business, exemplary through fraud or malicious actions to customers. Such embodiments may result in automated responses detailing the basis for such a prediction and/or assigning more monitoring to the employee, or scheduling of meeting with managers, supervisors, or human resources personnel to discuss identified issues.

In exemplary embodiments of systems and methods as disclosed herein, the customer interaction is analyzed across multiple channels of collected information. The predictive analysis is applied to the results of normalized multi-channel customer interaction data which can provide valuable insights not currently available.

In some embodiments, an outcome such as whether or not a customer increased sales or decreased sales or left for a competitor may be known. In these cases, the customer interactions of such a customer can be analyzed at varying time periods before the identified outcome in order to evaluate what a customer interaction looks like with a customer exemplarily one week or one month prior to an outcome such as an increasing sales, decreasing sales, or leaving for a competitor. In other embodiments, the outcomes are not known. In these such cases, the more statistical approach can be taken in order to identify what “normal” looks like in a variety of channels or combinations of channels for an interaction and an effort is made to identify which customer interactions are abnormal. Those customer interactions that are identified as abnormal can be separated for further analysis in order to identify employee, business, or customer issues present in abnormal customer interactions.

FIG. 3 is a flowchart that depicts an exemplary embodiment of a method 50 of real-time predictive modeling. It will be noted that in the embodiment of the method 50 depicted in FIG. 3 that portions of the flow chart are the same as, and identified with, the same reference numerals as corresponding features described above with respect to FIG. 1. It will be noted that in embodiments, these features are also present in the method 50 and the description as provided above with respect to FIG. 1 are similarly applied to such embodiments in the method 50. It will also be understood that alternative embodiments of method 50 may use a portion of these features as described above with respect to FIG. 1 and remain within the scope of the presently disclosed method.

Focusing now on specific aspects of the method 50 depicted in FIG. 3, after the structured data is created at 22, the structured data is sorted at 52. In an exemplary embodiment, the structured data of the interaction recordings and the desktop analytics are sorted with the structured data of the transactional data and the customer feedback surveys. From this, correlations between interaction outcomes as represented by the transaction data and customer sentiment as represented by the customer feedback surveys with the content and processes of the customer service interactions can be determined. By such sorting of the structured data, structured data of interaction recordings and desktop analytics that resulted in positive customer reviews, sales, up sales, or cross sales, may be looked at as a group in order to identify the characteristics of interactions and agent processes that are more likely to result in positive outcomes. Similarly, those interactions and processes related to positive outcomes and evaluations may be compared to those interactions and processes that resulted in negative outcomes or negative customer reviews to identify the areas in which the customer service interactions or processes diverge.

In still further embodiments, more detailed aspects of the transactional data or customer feedback survey may be used to sort the structured data of the interaction recordings and desktop analytics to focus in on more specific events. Exemplarily, the structured data may be stored to only look at the interaction recordings and desktop analytics that resulted in a cancellation of service in favor of a particular competitor. In doing so, the structured data of the interaction recordings and desktop analytics handling these interactions may be investigated further in order to evaluate the processes and reasons for the cancellation. In a still further embodiment, the sorting of the structured data at 52 may begin with selecting all of the structured data of interaction recordings when a customer mentions a specific topic, for example, “cancellation of service.” After sorting out this set of interaction recording structured data, then this reduced set can be further sorted based upon the transactional data to make comparisons to those interactions wherein a customer raised the issue of cancellation and followed through to cancellation whereas in other interactions the customer raised the topic of cancellation but did not result in the cancellation of service. Differences between these groups of customer service interactions can be evaluated for indications as to which outcome is more likely based upon further customer statements.

At 54, predictive analysis algorithms are derived from the sorted structured data. As described above, differences in the structured data of the interaction recordings that resulted in different outcomes or customer evaluations can be used to build models, rules or other types of algorithms to predict which outcome is more likely based upon the current information of a customer service interaction. Such exemplary predictive analysis algorithms may identify that customers who raise the issue of cancellation are at a risk or far more likely to cancel a service than those customers who do not raise the issue. However, it may be further determined that this risk is significantly reduced if the customer service agent offers a promotion or reduced price, therefore the predictive analysis algorithm may indicate a higher risk of proceeding to cancellation from the point at which a customer raises the issue of cancellation until the customer service agent replies with a promotion or reduction of service fee. Further agent statements or sentiments, expressing sympathy, maintaining a friendly or congenial tone may be further identified with a further reduction in likelihood that a customer will cancel services. Therefore, while sonic predictive analysis algorithm may be the identification of a single word or topic raised in a customer service interaction, other predictive analysis algorithms may include a fuzzy logic, or lattices, or networks of sequences of various events or statements that have been determined to increase or decrease the likelihood of any one particular outcome or evaluation.

At 56 the predictive analysis algorithms are applied to real-time customer interaction content data from an ongoing customer interaction between a customer service agent and a customer. In an exemplary embodiment, the real-time customer interaction content data is streaming audio data. However, in alternative embodiments, the real-time customer interaction content data may be the text transcript of a web chat. In still further embodiments, the real-time customer interaction content data may be the audio data of a customer service interaction that is further processed to automatedly transcribe the audio data such that predictive analysis algorithms based on textual analysis may be used. The application of the predictive analysis algorithms may exemplarily be the identification of words, terms, topics, sentiments in the customer interaction content data and the matching of these identified concepts to the predictive analysis algorithms, resulting in various predictions as to likelihood of various outcomes or evaluations.

Based upon the identified predictions from the application of the predicted analysis algorithms to the customer interaction content data at 56, one or more intra-interaction analysis may be presented to the customer service agent at 58. In an embodiment, the intra-interaction analysis is presented on a graphical display of the customer service agent workstation. In embodiments, the application of the predictive analysis algorithms at 56 may result in ongoing or periodically updated predications as to various outcomes; however, in embodiments, many of these predications may be kept hidden from the customer service agent and infra-interaction analysis only presented when particular types of predictions (e.g. negative outcomes, negative evaluations, or business opportunity) are identified. Furthermore, the intra-interaction analysis may only be presented when such predictions reach a particular threshold confidence level or likelihood as may be assessed by the predictive analysis algorithms.

In still further embodiments, the intra-interaction analysis is designed to be presented at 58 in a timely manner such that the customer service agent is able to act upon the analysis in order to either correct a predicted negative outcome or to take advantage of a predicted business opportunity. Such intra-interaction analysis may identify the predicted outcome or evaluation to the agent and may limiter include a prompt or some type of guidance that may be carried out by the agent in order to correct the negative outcome or variation or to take advantage of the predicated business opportunity. Non-limiting examples of guidance or prompts that may be presented to a customer service agent are described in more detail in U.S. Provisional Patent Application No. 61/729,073 entitled; “Use of Analytics Methods For Personalized Guidance”, which is incorporated herein by reference in its entirety.

This written description uses examples to disclose the invention, including the best mode, and also to enable any person skilled in the art to make and use the invention. The patentable scope of the invention is defined by the claims, and may include other examples that occur to those skilled in the art. Such other examples are intended, to be within the scope of the claims if they have structural elements that do not differ from the literal language of the claims, or if they include equivalent structural elements with insubstantial differences from the literal languages of the claims.

What is claimed is:

1. A method of predictive modeling of customer interaction content data, the method comprising:
collecting customer interaction content data;
analyzing the collected customer interaction content data to create structured interaction content data;
applying at least one predictive analysis algorithm to the structured data;
producing at least one prediction of an outcome based upon the application of the at least one predictive analysis algorithm to the structured data; and
generating at least one automated response to the at least one prediction.

2. The method of claim 1, wherein the customer interaction content data comprises at least interaction recordings.

3. The method of claim 2, wherein the customer interaction content data further comprises transactional data.

4. The method of claim 3, wherein the customer interaction content data further comprises desktop analytics and customer feedback surveys.

5. The method of claim 1, further comprising:
accessing, speech analytics, text analytics, and process analytics; and
applying the speech analytics, text analytics, and process analytics to the collected customer interaction content data to create the structured interaction content data.

6. The method of claim 1, further comprising identifying at least one emerging trend from the structured interaction content data.

7. The method of claim 1, wherein the at least one prediction of an outcome comprises a prediction of a customer action, and the automated response comprises a guidance message directed to a customer service agent.

8. The method of claim 7, wherein the at least one prediction of an outcome further comprises a prediction of an employee action and a prediction of a business outcome and the at least one automated response comprises a notification directed to a management personnel, the method further comprising:
in response to a prediction of a customer action, automatedly venerating a guidance message at a computer workstation of the customer service agent; and
in response to a prediction of an employee action or a business outcome, generating a reporting message at a computer workstation of a management personnel.

9. The method of claim 1, wherein the at least one predictive analysis algorithm defines a normal customer service interaction, and the application of the at least one predictive analysis algorithm to the structured data identifies an abnormal customer service interaction in the structured data.

10. The method of claim 1, wherein the at least one predictive analysis algorithm defines a likelihood of a negative outcome, and the application of the at least one predictive analysis algorithm to the structured data identifies a likelihood of the negative outcome in the structured data.

11. A method of predictive modeling of customer interaction content data, the method comprising:
collecting customer interaction content data;
analyzing, the collected customer interaction content data to create structured interaction content data;
deriving at least one predictive analysis algorithm from the structured interaction content data;
applying the at least one predictive analysis algorithm to as real time stream of customer interaction content data acquired from an interaction between a customer and a customer service agent; and
presenting at least one intra-interaction analysis at a workstation for the customer service anent.

12. The method of claim 11, wherein the customer interaction cement data comprises interaction recordings, transactional data, desktop analytics, and customer feedback surveys.

13. The method of claim 12, further comprising, applying speech analytics, text analytics, and process analytics to the collected customer interaction content data to create the structured interaction content data.

14. The method of claim 13, further comprising, sorting the structured interaction. content data, wherein the at least one predictive analysis algorithm is derived from the sorted structured interaction content data.

15. The method of claim 14, further comprising:
selecting the structured interaction content data from the interaction recordings as selected data;
sorting the selected data based upon the transactional data to identify the selected data that is correlated to a particular outcome in the transactional data as identified data; and
deriving the at least one predictive analysis algorithm from the identified data.

16. The method of claim 14, wherein the transaction data comprises cancellation of service, and the identified data comprises structured data from interaction recordings correlated to cancellation of service.

17. The method of claim 14, further comprising, selecting the structured interaction content data from the desktop analytics as the selected data.

18. The method of claim 14, further comprising sorting the selected data based upon the structured data from the customer feedback surveys to identify the selected data that is correlated to a particular outcome in the customer feedback surveys as the identified data.

19. The method of claim 11, wherein the at least one intra-action analysis is an automated guidance to the customer service agent, and further comprising:
generating a predicted outcome from the application of the at least one predictive analysis algorithm to the real time stream of customer interaction content data;
wherein the automated guidance is based upon the predicted outcome.

20. A system for predictive modeling of customer interaction data, the system comprising:
a computer readable medium upon which customer interaction content data is stored, the customer interaction content data comprising interaction recordings, transactional data, desktop analytics, and customer feedback surveys;
a processor communicatively connected to the computer readable medium upon which the customer interaction content data is stored, the processor analyzes the customer interaction content data to create structured data and applies at least one predictive analysis algorithm to the structured data to result in at least one customer prediction, at least one employee prediction, and at least one business prediction, the processor creates at least one customer response from the customer prediction, at least one employee response from the employee prediction, and at least one business response from the business prediction;
a first workstation comprising a graphical display, the graphical display operated by the processor to automatedly present the customer response; and
a second workstation comprising a graphical display, the graphical display communicatively connected to the processor and configured to present the employee response and business response.
